(19) United States
(12) Patent Application Publication
(10) Pub. No.: US 2015/0310175 A1
(43) Pub. Date: Oct. 29, 2015

(54) METHOD AND SYSTEM OF HANDLING BIOLOGICAL ASSETS THROUGH A BIO-REPOSITORY

(71) Applicant: Rajesh BEHL, El Cerrito, CA (US)

(72) Inventor: Rajesh BEHL, El Cerrito, CA (US)

(21) Appl. No.: 14/693,181

(22) Filed: Apr. 22, 2015

Related U.S. Application Data
(60) Provisional application No. 61/983,558, filed on Apr. 24, 2014.

(51) Int. Cl. G06F 19/00; H04L 29/06; G06F 17/30

(52) U.S. Cl. CPC G06F 19/322; G06F 17/30321; G06F 19/366; H04L 63/0428; H04L 63/0861

(57) ABSTRACT

Embodiments of the disclosure relate to system and a method for handling biological assets through a bio-repository. In an embodiment, the present disclosure provides a system by which owner of the biological asset can store their biological samples and control the usage of the biological sample. Each time the biological sample is used, consent is requested by the bio-repository from the owner of the biological sample.

### TECHNICAL FIELD

The present disclosure relates to biological materials. In particular, the present disclosure relates to a system and a method for managing, biological assets through a bio-repository.

### BACKGROUND

Biological materials of all kinds have been collected, stored and used for various purposes since the beginnings of scientific medicine. The numerous collections of biological materials established for the purposes of medical diagnosis, education or therapy in the past, have now assumed great value for research owing to the development of new techniques of molecular genetic analysis. The advances in medical diagnostics and genome sciences are increasing the need of biological materials for purpose of personalized medicine,. There are countless collections of different sizes, purposes and types of biological materials in research institutions, e.g. university departments or the pharmaceutical industry, for diagnosis, therapy, research or the clinical testing of medicines.

However, in consequence of modern methods of molecular genetic analysis and electronic data processing, there is a question on the need for regulation of such collection and usage. Presently, in most cases the donors may not have consented to the use of their samples for research, in particular, for specific genetic investigations. This raises the question of whether the use of the bodily substances for research can be justifiable.

Therefore, there is need for specific regulation in this field. The central element of the regulation must be the donor's right of self-determination. This means that the collection of bodily substances from his body and the gathering of personal data, in both cases for the purposes of medical research, must be subject to the donor's consent. Also, benefit sharing is a very sensitive issue and is not considered in present solutions. Benefit from the research results, especially the financial benefit, could be shared among donors, who take part in research.

Donors currently do not have efficient mechanisms to store and control personally their bodily samples for future personal and other uses. Presently, there is no mechanism for individuals to get complete control over use of their biological assets, especially to get financial gains accruing from research on their biological material. In some setups, at the time of depositing/donating their specimen, the individuals are required to waive any rights to financial profits accruing from their biological assets. Also, there does not exist a model for the valuation of biological assets to allow for fair benefit sharing with donors of the financial gains accruing from such assets. Therefore, donors have little incentive to deposit these biological assets as the financial incentives and distribution control resides with the hospitals or research organizations performing clinical trial and clinicians.

### SUMMARY OF THE DISCLOSURE

The shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

An embodiment of the present disclosure relates to a method of managing biological samples through a bio-repository. The method comprises receiving at least one biological sample of one or more entities by the bio-repository and receiving information relating to the received at least one biological sample. The information includes unique id indicating at least one of ownership and guardianship of the at least one biological sample. Further, the method comprises indexing the received information in a database of the bio- repository for information processing at a later time and optionally retrieving the information related to the at least one biological sample by a processor communicably connected to the database of the bio-repository. The information is retrieved from the indexed information upon user request for information on the at least one biological sample. Then, the method comprises providing, the at least one biological sample upon receiving request from the user for the at least one biological sample, wherein consent from one of owner and guardian of the at least one biological sample is obtained before providing the at least one biological sample to the user.

In an embodiment, the present disclosure relates to a system for managing biological samples through a bio-repository. The bio-repository comprises at least one biological sample of one or more entities and information related to the at least one biological sample, wherein the information includes unique id indicating at least one of ownership and guardianship of the at least on biological sample. The system comprises a database configured to store the information related to the at least one biological sample, and a processor communicably connected to the database of the bio-repository. The processor is configured to index the information in the database of the bio-repository for information processing at a later time and optionally retrieve the information related to the at least one biological sample. The information is retrieved from the indexed information upon user request for information on the at least one biological sample. The bio-repository provides the at least one biological sample upon receiving request from the user for the at least one biological sample, wherein consent from one of owner and guardian of the at least one biological sample is obtained before providing the at least one biological sample to the user.

The aforementioned and other features and advantages of the disclosure will become further apparent from the following detailed description of the presently preferred embodiments, read in conjunction with the accompanying drawings. The detailed description and drawings are merely illustrative of the disclosure rather than limiting, the scope of the disclosure being defined by the appended claims and equivalents thereof.

### BRIEF DESCRIPTION OF THE ACCOMPANYING DRAWINGS

The features of the present disclosure are set forth with particularity in the appended claims. The embodiments of the disclosure itself, together with further features and attended advantages, will become apparent from consideration of the following detailed description, taken in conjunction with the accompanying drawings. One or more embodiments of the present disclosure are now described by way of example only, with reference to the accompanied drawings wherein like reference numerals represent like elements and in which:

FIG. 1 illustrates a system for managing biological samples through a bio-repository in accordance with some embodiments of the present disclosure; and

FIG. 2 illustrates a flowchart showing method for managing biological samples through a bio-repository in accordance with some embodiments of the present disclosure; and

FIG. 3 illustrates a block diagram of an evaluation model in accordance with some embodiments of the present disclosure.

The figures depict embodiments of the disclosure for proposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

An embodiment of the present disclosure relates to a method and system for managing biological samples where control and autonomy of the entity over their biological asset can be provided through direct control such as the entity using a safe deposit box of a bank or using the a third party organization for storing the biological sample. In the safe deposit model, the repository specimens can include, but are not limited to, be live tissues, fixed tissue, DNA, and RNA, which have potential of both diagnostic and therapeutic benefit. This would allow depositors to take the greatest advantage in the evolving field of personalized medicine.

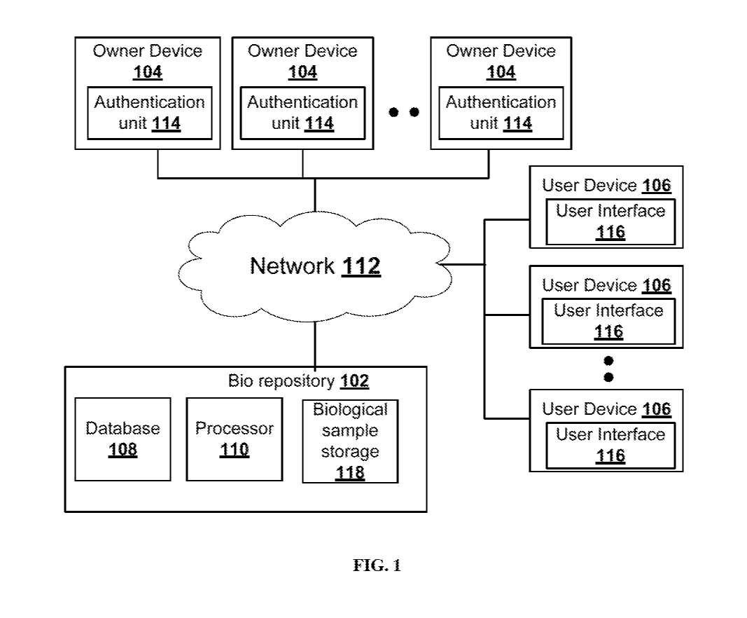

FIG. 1 illustrates a system for managing biological samples through a bio-repository in accordance with some embodiments of the present disclosure. The system comprises a bio-repository 102, one or more owner devices 104 and one or more user devices 106. The bio-repository comprises a database 108, a processor 110 and biological sample storage 118. The bio-repository 102 stores biological samples of entities and the database 108 stores information relating to the biological samples. The database 108 refers to any type of physical memory on which information or data readable by a processor may be stored. Examples include Random Access Memory (RAM), Read-Only Memory (ROM), volatile memory, nonvolatile memory, hard drives, CD ROMs, DVDs, flash drives, disks, and any other known physical storage media. The bio-repository 102 stores the biological samples with proper security and under suitable conditions for each of the biological sample in the biological sample storage 118. The biological samples of all the entities may be stored at one location. In an alternate embodiment, the biological sample may be collected and stored at different locations based on the geographical locations of the entities or other predefined conditions. In such a situation, the biological sample storage 118 and the database 108 associated to the storage 118 may be connected to each other using a distributed network, e.g. cloud. The processor 110 handles all the transactions relating to the biological samples on behalf of owner of the biological sample. The bio-repository 102, the one or more owner devices 104 and the one or more user devices 106 are connected to each other through a network 112. It will be understood by one skilled in the art that connections to the network 112 may be wired, wireless or any combination thereof. For example, bio-repository 102, the one or more owner devices 104 and the one or more user devices 106 may be connected to the risk assessment computing device 100 through wireless local area network (WLAN) technologies (e.g.. Wi-Fi, 3G, Long Term Evolution (LTE)) or through a physical network connection to a computer network router or switch (e.g., Ethernet).

The one or more owner devices 104 comprise an authentication unit 114 for authenticating the true owner of the biological sample. The owner device 104 is managed by one of owner of the biological sample or a guardian of the owner of the biological sample. The authentication is required for conducting transaction of the biological sample. Further, the one or more user devices 106 are managed by a user and comprise a user interface 116. The user interface 116 is configured to receive requests for information as well as request for biological samples from the bio-repository 102. In an embodiment, the entity is any life form. The life forms can include, but are not limiting to, human, animals, birds, plants and microorganisms. Further, the at least one biological sample of the entity includes, but are not limited to, Deoxyribonucleic Acid (DNA), Ribonucleic Acid (RNA), cells, clones, tissues, organs, blood and swab.

Further, the users requesting for information on biological samples and biological samples can include, but are not limiting, to, healthcare organizations like pharmaceutical organizations, academic researchers, contract research organizations and clinicians.

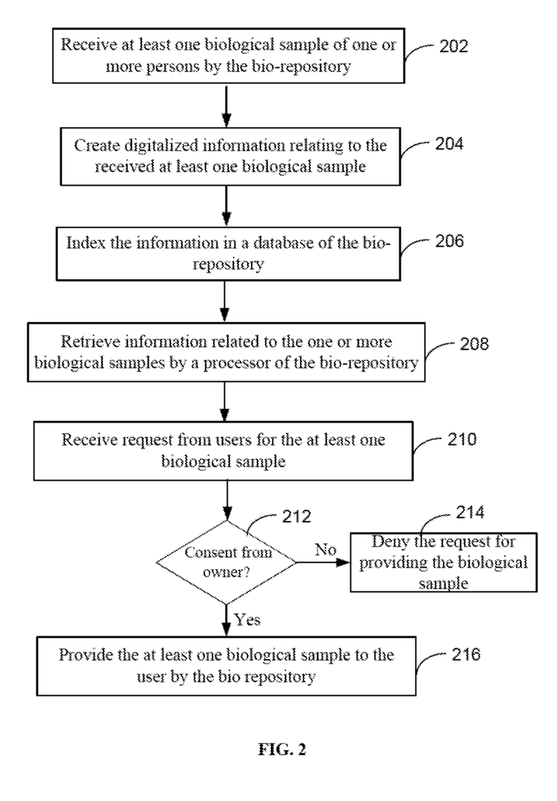

FIG. 2 illustrates a flowchart showing method for managing biological samples through a bio-repository in accordance with some embodiments of the present disclosure.

Initially, the samples are accumulated at the bio-repository 102. At step 202, receive, by the bio-repository, at least one biological sample from one or more entities. In an embodiment, the one or more entities providing the biological sample also provide information about themselves as well as the sample. The information may include, but is not limited to, disease affecting the biological sample.

At step 204, create digitalized information for the received biological sample.

At step 206, the one or more information relating to the received biological sample is then stored in the database 108 of the bio-repository 102. In case, the entity is new to the bio-repository, then an account is opened for the entity. The account information required for registering the entity may include, but is not limited to, personal details of the entity, trustee for the biological sample, beneficiary in case of transaction of the biological sample, authentication mechanism for the entity, guardian for the entity, maintenance fee for storing the biological sample, predefined value of the biological sample etc. In another case, if the entity has already an account with bio-repository, then the newly added biological sample is stored in the biological sample storage 118. Also, information about the newly added biological material of the entity is retrieved from the entity and stored in the existing account of the entity.

In an embodiment, the one or more information is encrypted and stored for maintaining security of the information as the entity may not interested in sharing all the personal details with one or more users. The information and/or samples of the entity can be recurrently collected at predefined intervals of time based on the requirement of the biological samples and life span of the biological samples. In an embodiment, the entity providing the at least one biological sample to the bio-repository 102 is the owner of the biological sample and has all the rights over the biological sample and information of the biological sample. The bio-repository 102 takes consent from the owner of the biological sample before providing information about the biological sample as well as the biological sample to any third party. In case, the entity is not able to provide consent/take decisions, then a guardian is appointed on behalf of owner of the biological sample who has same rights as the owner of the biological sample. The owner or the guardian of the biological sample has control over the biological sample and information of the biological sample. In an embodiment, the owner provides consent for using the biological sample by the third party in a predefined way. For example, if the owner has consented to provide the biological sample to third party for research, then the third party can use the biological sample for research purposes only. The third party cannot monetize on the biological sample by any other means without the permission of the owner. In an embodiment, the entity, i.e. owner of guardian of the biological sample has to pay a predefined amount to the bio-repository 102 for storing the biological sample.

At step 208, retrieve information related to the one or more biological samples by the processor of the repository. Now, a user interested in some of the biological samples stored in the bio-repository 102 requests information related to the one or more biological samples. In an embodiment, the user requests for information using the user interface 116 configured in the user device 106. The user can be provided with a search interface using which the user can search the required biological sample. As a non-limiting, example, the user can search the biological samples by type of sample, type of disease, blood group etc. If the entity providing the biological sample has not requested for maintaining privacy, then the search can also display the entity providing the biological sample. In another embodiment, the user can directly go to the bio-repository 102 to retrieve information on one or more biological samples. The one or more information related to the biological sample is retrieved by the processor 110 of the bio-repository 102 upon receiving request from user using the user device 106.

Then the user requests at least one biological sample from the bio-repository 102. At step 210, this request for at least one biological sample is received by the bio-repository 102. In an embodiment, the user checks the database categorizing the information on stored biological samples and the user uses the user interface to evaluate and scan the inventory and bid for the asset. Then, the bio-repository 102 requests for consent from the owner of the biological sample. In an embodiment, the owner or guardian of the biological sample is first authenticated through authentication unit 114 configured in the owner device 104. The authentication can be performed by biometrics such as retina scan or fingerprint scan, voice scan, face recognition, iris scan, signature recognition etc. Also, the authentication can be performed by methods like passwords or a pin number. Alternatively, the owner of the biological sample can be authenticated by using a unique key, card or token uniquely assigned to the owner. A person skilled in the art would understand that other methods of authentication can be used with the present disclosure. After the authentication, consent is provided by the owner or guardian of the biological sample. If the owner provides the consent, then the bio-repository 102 provides the biological sample to the requesting user upon receiving the predefined value of the biological sample from the requesting user. In the alternative, if the owner of the biological sample does not provide consent, then the bio-repository 102 denies the request for providing the biological sample.

In an embodiment, the owner may consent to provide the biological sample by one or more ways like selling, leasing or donation of the biological sample. Further, the owner of the biological sample may consent to provide the biological sample at a predefined value of the biological sample. In a non-limiting example, the value of the biological sample is defined based on the type of biological sample, disease affecting the biological sample, demand for the biological sample, rarity of the biological sample, quality of the sample, quality of the paired clinical data, quantity of biological samples, number of time points of deposit of assets etc.

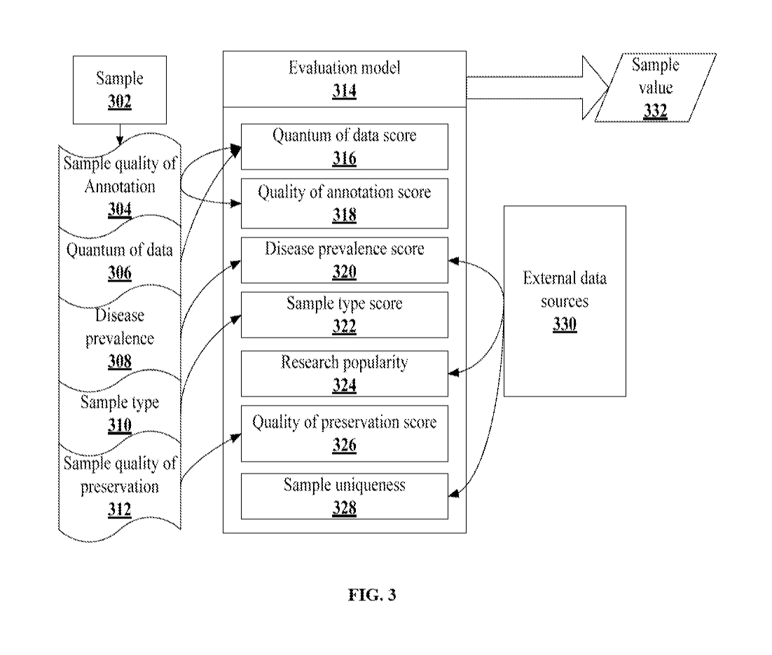

FIG. 3 illustrates a block diagram of an evaluation model 314 for evaluating value of the biological sample 302 in accordance with some embodiments of the present disclosure.

In one embodiment, the value of the biological sample 302 is determined by using an evaluation model. When the owner consents for providing the biological sample, then a value of the biological sample 332 is determined using one or more parameters. This helps. the owner to determine a reasonable value for the biological sample. The value depends upon intrinsic parameters, extrinsic parameters and other parameters. The intrinsic parameters are properties of the sample itself and are unique to the sample which may include sample type 310, sample quality of preservation 312, sample quality of annotation 304. The extrinsic parameters are properties of a class of sample rather than individual samples which may include disease prevalence 308, end user value etc. Other parameters include parameters which are neither intrinsic nor extrinsic such as specimen uniqueness, quantum of data 306 etc. In an embodiment, each parameter is assigned with a score on interval [0, 1].

Sample type 310 relates to type of the biological sample and also defines how the sample is inherently more valuable than other samples. For example, a myocardial biopsy. which is rarely performed, is much more valuable than a relatively common blood or marrow sample. The score of the sample type 322 is as given in equation 1 and is a function of commonness of procedure and the level of pain involved in collecting the biological sample.

S_{type}=P_{type}e^{(P}^{_{type}}^{-9C}^{_{type}}⁻¹⁾ 1

Where, S_{type} the score of the sample type,
P_{type} is level of pain involved in collecting the biological sample and
C_{type} is commonness of procedure involved in collecting the biological sample.

Sample quality of preservation 312 is dependent on the method of preservation. In an embodiment, better a sample is preserved, the greater its research value. For example, live cryopreservation carries more value than paraffin block preservation. The scoring function for the sample quality of preservation 326 is given as in equation 2.

$${S}_{SQoP} = \frac{{C}_{SQoP}}{[ 1 + {e}^{( 10 - 400 {C}_{SQoP} )} ]} \qquad 2$$

where, S_{SQoP} is sample quality of preservation and
C_{SQoP} is percentage of living, cells for cells preserved
   S_{SQoP} 326 is a function of the percentage of living, cells for cells preserved and is generally linear over [0,1] but incorporates a small dip when C_{SQoP} is equal to 3% in order to devalue specimens with is lesser than 3% of living cells.

Sample quality of annotation 304 can be measured simply as the ratio of filled fields to total fields from Electronic Hospital Records (EHR) for the sample which is given as in equation 3:

$${Q}_{SQoA} = \frac{number of fields filled}{number of available fields} \qquad 3$$

Where, Q_{SQoA} is sample quality of annotation.

Sample quality of annotation score 318 is given as in equation 4.

$${S}_{SQoA} = \frac{1}{1 + {e}^{[ - 10 ( {Q}_{SQoA} - 0.5 ) ]}} \qquad 4$$

where, S_{SQoA} is sample quality of annotation score.

The function of S_{SQoA} 318 is a sigmoid scoring function of Q_{SQoA} 304 in order to minimize the difference in value between two poorly annotated specimens, minimize the difference in value between two well-annotated specimens, and maximize the difference in value between a poorly annotated and a well-annotated specimen.

As prevalence of a disease 308 related to the biological sample increases, the value of the biological sample decreases due to increased supply. Therefore, an exponential disease prevalence score is assigned based on percentage of affected individuals which is given by equation 5.

Sₚᵣₑᵥ=e^{(-90 P}^{ₚᵣₑᵥ}⁾ 5

where, Sₚᵣₑᵥ is the disease prevalence score and
Pₚᵣₑᵥ is percentage of affected individuals.
   The disease prevalence score 320 as in equation 5 is exponential in order to decrease values of diseases affecting more than or equal to 5% of the population and greatly increase value of those affecting lesser than 5% of population. The disease prevalence score is obtained from external data sources 330.

End user value relates to research popularity 324 of the biological sample 302 which is given by the equation 6. In an embodiment, the National Center for Biotechnology Information's (NCBI) Entrez Programming Utilities may be used to query NCBI database.

$${S}_{pop} = 1 - \frac{1}{1 + {e}^{[ \frac{1}{{C}_{pop}} ( {M}_{pop} - {C}_{pop} ) ]}} \qquad 6$$

where, Sₚₒₚ score of the research popularity,
Mₚₒₚ is number of mentions of disease related to the sample obtained from NCBI database, and
Cₚₒₚ is an arbitrary value.

Function of the score of the research popularity 324 as in equation 6 is sigmoid function as explained for the sample quality of annotation score in order to minimize the difference in value between two less-popular specimens, minimize the difference in value between two popular specimens, and maximize the difference in value between an unpopular and a very popular specimen.

Sample uniqueness 328 relates to genomic profile signature of the sample as well as the uniqueness of a specific mutation also which can increase the value of the sample. The sample uniqueness score is given as in equation 7 which depends on number of similar samples existing. Sample uniqueness is obtained from the external data sources 330 which may a sample market.

S_{uniq}=e^{(-N}^{_{uniq}}⁾ 7

where, S_{uniq} is sample uniqueness score and
N_{uniq} is number of similar samples existing.

Quantum of data 306 relates to having multiple samples of same specimen over a period of time to examine progression of a condition of the sample and score of the quantum of data 316 is given as in equation 8.

$${S}_{QoD} = {δ}_{{N}_{QoD}}^{2} [ 1 - \frac{1}{1 + {e}^{( {N}_{QoD} - {C}_{QoD} )}} ] \qquad 8$$

where, S_{QoD} is the score of quantum of data,
δ is kronecker delta, such that when there are no other associated sample. S_{QoD}=0,
N_{QoD} is number of Ivies associated with the specific specimen per accepted unit of time, and
C_{QoD} is the knee point of the sigmoid function.

In one embodiment, the value of the biological sample 332 may be given as in equation 9.

$${V}_{S} = \frac{k}{p} {{Σ}_{n = 1}^{p} ( 1 + {P}_{c} )}^{{v}_{n} ( p - n + 1 )} \qquad 9$$

where, V_{S} is the value of the biological sample,
k is normalizing constant,
p is number of parameters,
P_{c} is prioritization constant..
vₙ is piecewise function which returns a different parameter score based on the value of subscript n and
N is integer varying from 1 to p.

Table 1 gives an exemplary embodiment case for determining value of polycythemia vera marrow sample depending upon the scores of the parameters.

TABLE 1

| Priority | Parameter | Properties | Score |
|---|---|---|---|
| 1 | Sample type | Bone marrow | 0.140 |
| | | 5% of people undergo this | |
| | | procedure | |
| | | 40% pain involved | |
| 2 | Sample quality of | 75% live cells | 0.750 |
| | preservation | | |
| 3 | Sample quality of | 90% of available fields | 0.982 |
| | annotation | filled | |
| 4 | Disease prevalence | 0.045% of people | 0.960 |
| 5 | Quantum of data | 0 associated samples per | 0.000 |
| | | time period | |
| 6 | Sample uniqueness | This is one of 5 portions of a | 0.018 |
| | | larger original sample, so | |
| | | there are 4 similar ones | |
| 7 | Research | 10872 results in NCBI for | 0.388 |
| | popularity | “Polycythemia vera” | |

From the scores obtained from the table, the polycythemia vera marrow sample value is computed as 1.24 k.

Table 2 gives another example case for determining value of glioblastoma multiforme glial biopsy depending upon the scores of the parameters.

TABLE 2

| Priority | Parameter | Properties | Score |
|---|---|---|---|
| 1 | Sample type | Glial cell biopsy | 0.654 |
| | | 0.01% of people undergo | |
| | | this procedure | |
| | | 80% pain involved | |
| 2 | Sample quality of | 25% live cells | 0.250 |
| | preservation | | |
| 3 | Sample quality of | 80% of available fields | 0.953 |
| | annotation | filled | |
| 4 | Disease prevalence | 0.002% of people | 0.998 |
| 5 | Quantum of data | 3 associated samples per | 0.119 |
| | | time period | |
| 6 | Sample uniqueness | 0 other similar samples | 1.000 |
| 7 | Research | 168745 results in NCBI for | 0.999 |
| | popularity | “Glioblastoma multiforme” | |

From the scores obtained from the table, the glioblastoma multiforme glial biopsy value is computed as 1.298 k.

In an embodiment, the owner of the at least one biological sample can withdraw the biological sample or the consent to provide the biological sample at any time. Further, if the owner or the guardian of the biological sample is unable to pay maintenance fee for storing and managing the biological sample to the bio-repository 102, the bio-repository can transfer the ownership of biological owner from the owner to the bio-repository 102. Also, the bio-repository can refuse to accept a biological sample from an entity based on one or more conditions. The conditions can be like the bio-repository does not have proper storage for storing the biological sample etc..

This written description uses examples to disclose embodiments of the present disclosure, including the best mode, and also to enable any person skilled in the art to practice the technology disclosed in the present disclosure, including making and using any devices or systems and performing any incorporated methods.

1. A method of managing biological samples through a bio-repository, said method comprising:
receiving at least one biological sample of one or more entities by the bio-repository;
receiving information relating to the received at least one biological sample, wherein the information includes unique id indicating at least one of ownership and guardianship of the at least one biological sample;
indexing the received information in a database of the bio-repository for information processing at a later time;
optionally retrieving the information related to the at least one biological sample by a processor communicably connected to the database of the bio- repository, wherein the information is retrieved from the indexed information upon user request for information on the at least one biological sample; and
providing the at least one biological sample upon receiving request from the user for the at least one biological sample, wherein consent from one of owner and guardian of the at least one biological sample is obtained before providing the at least one biological sample to the user.

2. The method as claimed in claim 1, wherein the entity providing the at least one biological sample is the owner of the biological sample, said entity has right over the biological sample.

3. The method as claimed in claim 1, wherein the guardian of the at least one biological sample has rights over the biological sample.

4. The method as claimed in claim 1, wherein the entities are life forms selected from a group comprising human, animals, birds, plants and microorganisms.

5. The method as claimed in claim 1, wherein the guardian of the at least one biological sample is authorized to act on behalf of the entity of the at least one biological sample.

6. The method as claimed in claim 1, wherein the indexing of the information relating to the at least one biological sample comprises encrypting the information.

7. The method as claimed in claim 1, wherein the owner of the at least one biological sample is provided with an option to withdraw at least one of the consent and the biological sample from the bio-repository.

8. The method as claimed in claim 1, wherein providing the at least one biological sample comprises selling, leasing and donation and other financial models of monetization of the at least one biological sample by the owner through the bio-repository.

9. The method as claimed in claim 1, wherein the information relating to the at least one biological sample comprises a predefined value of the at least one biological sample.

10. The method as claimed in claim 8, wherein providing the at least one biological sample comprises providing the at least one biological sample for the predefined value.

11. The method as claimed in claim 1, wherein the user is selected from a group comprising healthcare organizations including pharmaceutical organizations, academic researchers, contract research organizations and clinicians.

12. The method as claimed in claim 1, wherein the at least one biological sample is selected from a group comprising DNA, RNA, cells, clones, tissues, organs, blood and swab.

13. The method as claimed in claim 1, wherein the consent is provided by the owner after authentication of the owner using an authentication unit associated with said owner.

14. The method as claimed in claim 1, wherein the consent is provided by the guardian after authentication of the guardian using an authentication unit associated with said guardian.

15. The method as claimed in claim 1, wherein the authentication is performed using at least one of fingerprint scan and retina scan.

16. The method as claimed in claim 1, wherein the ownership of the at least one biological sample is transferred to the bio-repository upon non-renewal of maintenance of the biological sample by one of the owner and guardian of the at least one biological sample.

17. The method as claimed in claim 1, wherein the bio-repository is provided with an option to refuse receiving the at least one biological sample based on one or more predefined conditions.

18. A system for managing biological samples through a bio-repository, said bio-repository comprises at least one biological sample of one or more entities and information related to the at least one biological sample, wherein the information includes unique id indicating at least one of ownership and guardianship of the at least on biological sample, said system comprising:
a database configured to store the information related to the at least one biological sample; and
a processor communicably connected to the database of the bio-repository, is configured to:
index the information in the database of the bio-repository for information processing at a later time;
optionally retrieve the information related to the at least one biological sample, wherein the information is retrieved from the indexed information upon user request for information on the at least one biological sample;
wherein the bio-repository provides the at least one biological sample upon receiving request from the user for the at least one biological sample, and wherein consent from one of owner and guardian of the at least one biological sample is obtained before providing the at least one biological sample to the user.

19. The system as claimed in claim 16, wherein the processor indexes the information related to the at least one biological sample after encrypting the information.

20. The system as claimed in claim 16, wherein the guardian of the at least one biological sample is authorized to act on behalf of the entity of the at least one biological sample.

21. The system as claimed in claim 16, further comprising an owner device connected to the bio repository, said owner device includes an authentication unit for authenticating the owner of the at least one biological sample to provide consent.

22. The system as claimed in claim 16, wherein the user requests information on the at least one biological samples through a user interface configured on a user device.

23. The system as claimed in claim 16, wherein the user is selected from a group comprising healthcare organizations including pharmaceutical organizations, academic researchers, contract research organizations and clinicians.

24. The system as claimed in claim 16, wherein the at least one biological sample is selected from a group comprising DNA, RNA, cells, clones, tissues, organs, blood and swab.

25. The system as claimed in claim 16, wherein the ownership of the at least one biological sample is transferred to the bio-repository upon non-renewal of maintenance of the biological sample by one of the owner and guardian of the at least one biological sample.

26. The system as claimed in claim 16, wherein the bio-repository is provided with an option to refuse receiving the at least one biological sample based on one or more predefined conditions.
